(19) United States
(12) Patent Application Publication
(10) Pub. No.: US 2019/0385143 A1
(43) Pub. Date: Dec. 19, 2019

(54) SYSTEM AND METHOD FOR CONFIRMATION OF CREDIT TRANSACTIONS

(71) Applicant: McNabb Technologies, LLC a/k/a TouchCR, Chicago, IL (US)

(72) Inventor: David Reiss, Chicago, IL (US)

(21) Appl. No.: 16/012,171

(22) Filed: Jun. 19, 2018

(51) Int. Cl. G06Q 20/24; G06Q 20/40; G06Q 20/32; G06Q 20/34; G06Q 20/38; G06Q 30/02

(52) U.S. Cl. CPC G06Q 20/24; G06Q 20/4018; G06Q 20/3229; G06Q 30/0236; G06Q 20/351; G06Q 20/385; G06Q 20/3223

(57) ABSTRACT

A system and method to insure the security of a remote credit card transaction is disclosed. A merchant webserver generates a transaction interface on a device accessible by a consumer. The transaction interface allows entry of a mobile phone number and a credit card number. A transaction security server receives the mobile phone number and the credit card number. The transaction security server generates a code and sends the generated code to a mobile device corresponding to the entered mobile phone number. The transaction interface generates a code entry screen. The transaction security server verifies the transaction based on the received credit card number if an entered code from the code entry screen matches the generated code, at which point, the transaction is finalized.

### TECHNICAL FIELD

The present disclosure relates generally to a system to verify transactions, and more specifically, to a method and system to provide a double or two-factor authentication process for card not present transactions performed on line, (transactions where the credit card is not present).

### BACKGROUND

Credit card purchases are a convenient method for consumers to pay for transactions without having cash on hand. However, there is a problem with potential fraud and confirmation as a credit card consumer may deny/refute charges (chargebacks) or an unauthorized person may use a consumer's card. The credit card issuer needs a reliable method of determining whether the consumer is defrauding the credit card company (by claiming never to have made the charge or purchase and requesting a refund/credit—chargeback), or whether actual fraud has occurred whereby the consumer should not be held liable for unauthorized charges. For physical transactions (where the credit/charge card is present), verification is provided by a chip/card reader and allows for the checking a physical form of identification such as a driver's license and/or obtaining a signature.

However, an increasing number of credit card transactions are made online, such as those over a webpage and/or on a mobile application. For such transactions, there is currently no method to reliably determine whether the actual card holder is making the transaction. The only verifications available include validating the card number, expiry date, CVV, and or address or zip code. However, such mechanisms do not account for potential fraud by the card holder claiming not to have placed an order or that another party used the card or the actual theft and unauthorized use of the card because it is impossible to verify that the person entering the credit card information is actually the card holder. In addition, chargebacks by credit card holders who contest a transaction on their credit card are difficult and time-consuming to verify and, in many cases are fraudulent representations made by the actual cardholder.

Thus, there is a need for a verification/authentication mechanism to insure that a customer is making a legitimate transaction without examination of the actual card and to verify that the customer who consummated the transaction using a second factor, which is logged and stored, such as a verification/authentication code sent to the entered telephone number, which the customer enters into the web interface within the context of the transaction, to complete the transaction with the second factor of the two-factor authentication, validating the charge and subsequent confirmation to rebut a chargeback request. There is also another need to provide this dual confirmation mechanism: to prevent card holder fraud on credit card transactions and fraudulent claims of the card holder regarding the transaction and their request for a chargeback.

### SUMMARY

One disclosed example is a system to validate a remote transaction. The system includes a merchant webserver that generates a transaction interface on a device accessible by a consumer. The transaction interface allows entry of a mobile phone number and a credit card number. A transaction security server is operable to receive the mobile phone number and the credit card number. The transaction security server generates a code and sends the generated code to a mobile device corresponding to the entered mobile phone number. The transaction interface generates a code entry screen. The transaction security server verifies the transaction based on the received credit card number if an entered code from the code entry screen matches the generated code.

Another example is a method of protecting the security of transactional information. A transaction interface is generated on a customer computing device on a request for a credit card transaction. The interface requests a mobile phone number and a credit card number. A code is generated via a transaction security server. The code is sent to a mobile device associated with the mobile phone number. A code entry interface requesting the customer to input the generated code is presented. The received code is validated against the generated code. The credit card transaction is authorized based on the validation of the received code and the received credit card information.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a block diagram of an example transaction system between different customers and different merchants to allow the two-factor authentication of a credit card transaction;

FIG. 2A is a screen image of an interface generated on a mobile device for initial information for the two-factor authentication process in the system in FIG. 1;

FIG. 2B is a screen image of a second interface generated on a mobile device to provide information for initial verification;

FIG. 3A is a screen image of a pop up window generated to obtain a mobile number for verification;

FIG. 3B is a screen image of a pop up window generated on a mobile device to display the authorization code for the two-factor authentication system;

FIG. 4 is a screen image of a confirmation pop up window to accept the authorization code; and

FIG. 5 is a screen image of a check out interface generated on the mobile device.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

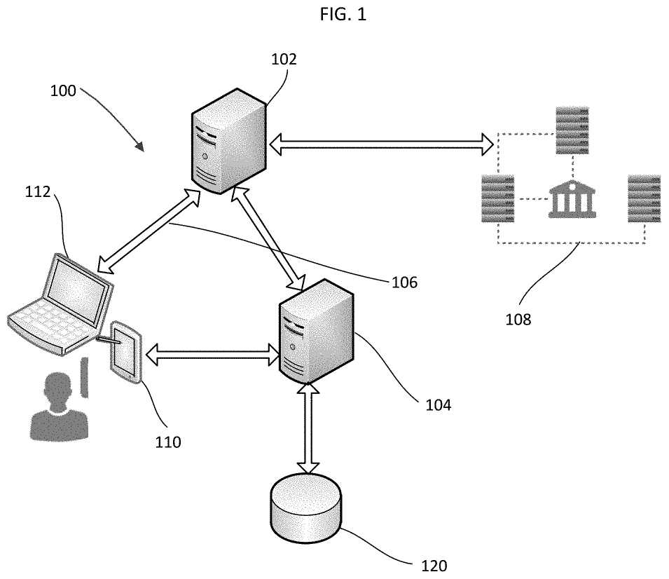

FIG. 1 is a block diagram of an example transaction system 100 for a consumer to use a credit card and allow a transaction with a merchant webserver 102 that interfaces with a transaction security server 104 through a network 106. Transactions received by the merchant webserver 102 are then processed by a payment processing system 108. The payment processing system 108 may be run by financial institutions, such as banks, that issue the credit card.

Transactions are received through the merchant web server 102 and reviewed by the security server 104. The customer has access to a mobile device 110, which in this example is smart phone with an associated mobile telephone number. In this example, the mobile device 110 has a display and is capable of SMS messaging. The customer may make transactions with a web browser operating on the mobile device 110 or a web browser operating on another computing device 112. The mobile device 110 and computing device 112 are connected to the network 106. The network 106 allows identification information relating to the consumer and credit card information to be exchanged between the transaction security server 104, the merchant website server 102. and the computing device 112. The transaction security server 104 has access to a transaction database 120 that includes customers and corresponding identification information such as mobile phone numbers. The transaction security server 104 may verify the authenticity of purchases from the merchant website 102 and insure that such transactions made with a credit card to the merchant are legitimately authorized by the consumer. A cellular network allows communication through text systems such as SMS from the transaction security server 104 to the mobile device 110.

The transaction security server 104 validates the customer acquisition transaction by using SMS based two factor authentication to confirm the customer is placing the order to the merchant website 102 by sending a one-time code to the customer's mobile phone 110 and requesting the customer enter this code before processing the credit card transaction. Thus, the customer using their credit card will be required to have a mobile number and validate the transaction by receiving and entering the one-time code on the mobile application. The transaction security server 104 will record the two factor authentication activity against the customer and order record to substantiate the “card not present” online transaction.

Thus, the recording of the two factor authentication against the card not present transaction can be used to combat fraudulent chargeback attempts by the customer. By sending the code to the consumer via an SMS message to their mobile number and completing the transaction only after the sent code is entered by the customer, the customer verifies that they are using the credit card, making it impossible to claim an unauthorized use to the credit card issuer or merchant.

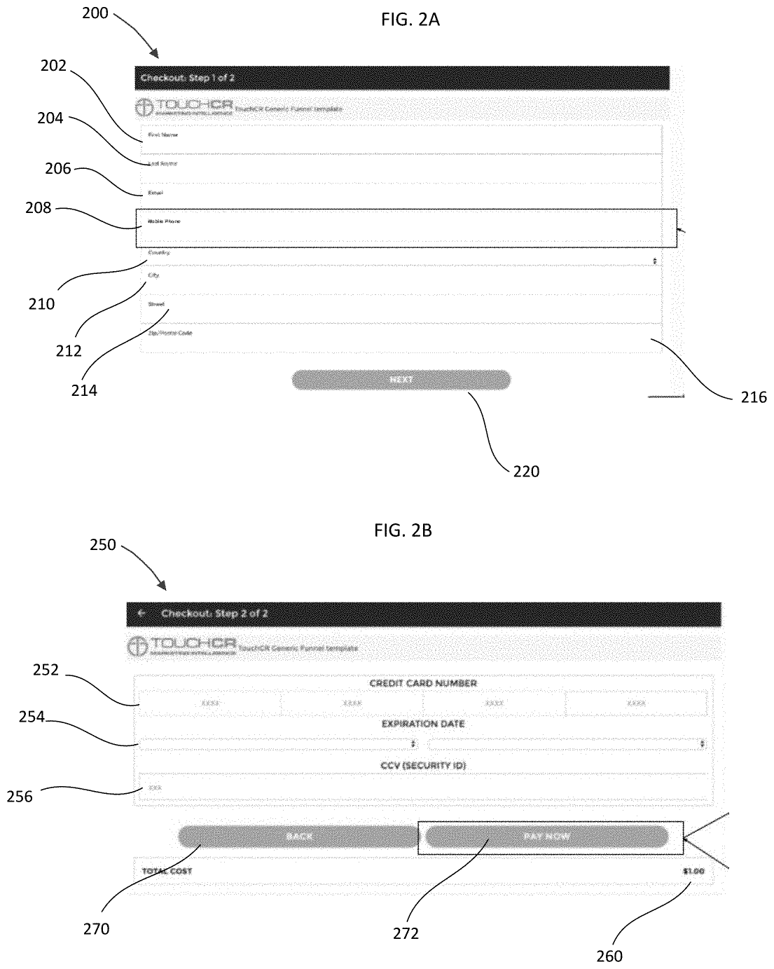

FIG. 2A is an image of a checkout interface 200 on use of a credit card on a website generated by the merchant server 102 in FIG. 1. The interface 200 may be accessed by a browser application running on the mobile device 110 in FIG. 1 or separately through a browser application running on the computing device 112 in FIG. 1 upon a customer visiting the merchant website and selecting goods or services for purchase via a credit card. The interface 200 has a number of entry fields for obtaining identification data from the customer. The entry fields include a first name field 202, a last name field 204, an email field 206, a mobile phone number field 208, a country field 210, a city field 212, a street field 214 and a postal code field 216. The mobile phone number field 208 is used to request the credit card holder to enter a mobile number. The entered mobile number is sent to the transaction security server 104 in FIG. 1 by the merchant server 102 through the network 106. Suitable security protocols may be used to encrypt the data received by the interface 200. Once the consumer enters the desired data, the consumer may proceed to complete the transaction by selecting a next button 220.

On entering the mobile number, the system will send the mobile number to the transaction security server 104 in FIG. 1. The system 100 will validate the received phone number is a valid mobile phone number and store the mobile phone number as a potential customer record to be stored in the database 120. The number entered is compared against the number generated into the interface to confirm the match. If a non-matching number is received, an error is displayed and the customer is asked to re-enter the number or re-send the number and repeat. In this example, the system 100 has a configurable limit on the number of non-matching entries for each generated number. The customer record will also include any other information entered by the customer on the entry fields 202, 204, 206, 210, 212, 214 and 216 in the interface 200 in FIG. 2A.

FIG. 2B is an image of a subsequent checkout interface 250 that appears on the browser application after a customer completes the information entry in the interface 200. The checkout interface 250 includes fields to allow a customer to complete the transaction via a credit card. The checkout interface 250 includes entry fields for credit card information. These fields include a credit card number field 252, an expiration date field 254, a security ID (CCV) field 254. The interface 250 also includes a total cost field 260 that shows the total amount of the transaction. The interface 250 includes a back button 270 that allows a customer to display the interface 200 in FIG. 2A. The interface 250 also includes a pay now button 272. Once the necessary credit card information is entered including the information from the interface 200, the pay now button 272 is activated. The customer may then select the pay now button 272 to complete the transaction. When the pay now button 272 is activated, the credit card information is sent from the computing device 112 to the transaction security server 104 through the merchant website server 102.

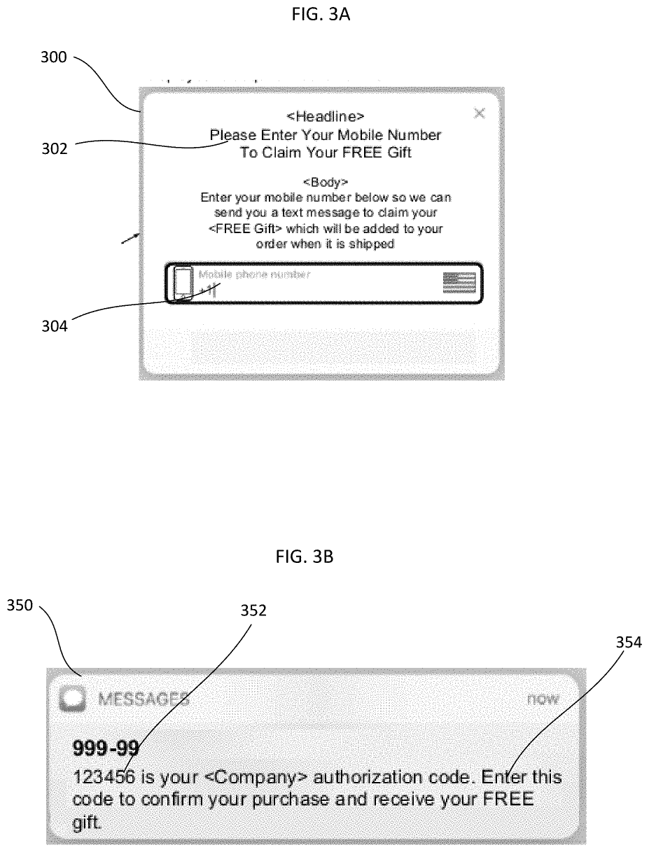

FIG. 3A is an image of a popup window 300 that appears on the interface 200 in cases where the customer does not provide a mobile number. The popup window 300 includes an incentive field 302 and a mobile phone entry field 304. The incentive field 302 includes an offer to incentivize the customer to enter the mobile phone number. For example, an incentive may include offering a free gift in exchange for entering the mobile phone number. Other incentives may include discounts on transactions or coupons for further purchases. The inclusion of an incentive is an option to incentivize customers to provide a mobile number and is not required for the operation of the system 100.

If the customer enters a mobile number, the system will send the number to the transaction security server 104. The transaction server security 104 will validate that the received phone number is a valid mobile phone number by checking the stored information in the database 120 or by other records. If the mobile phone number is valid, the transaction security server 104 will store the mobile phone number against potential customer record in the database 120. The transaction security server 104 may determine whether the entered mobile phone number is valid for the customer associated with the received information from the interface 200 via the database prior to sending the generated code or prior to proceeding. In this example, once a valid mobile phone number is received and verified, the second interface 250 in FIG. 2B is displayed to the customer on the browser application to complete the transaction. If no mobile number be entered, the validation process will prevent the completion of the transaction. The mobile number is a required field for the system 100.

A customer record based on the customer information is created by the transaction security server 104 for the database 120. In addition, an order record is created relating to the transaction in the database 120. Before the transaction is processed, a one-time-use code is generated and sent via SMS to the mobile phone number captured either via the interface 200 shown in FIG. 2A or via the popup window 300 shown in FIG. 3A. In this example, the code is a numeric code having five digits. It is to be understood that longer or shorter numbers of numerals may be used for the code. Further, the code may require letters or symbols for greater security.

A verification code screen is then displayed on the mobile application for the customer on the mobile device 110 in FIG. 1. FIG. 3B is an image of a text message 350 of a verification code capture screen/popup/modal that is displayed on the screen of the mobile device 110 in FIG. 1 with the submitted mobile phone number to display the generated code. The text message 350 includes a generated code field 352 and an instruction code field 354. As may be seen in FIG. 3B, additional incentives may be given to the customer in the instruction code field 354 for entering the code.

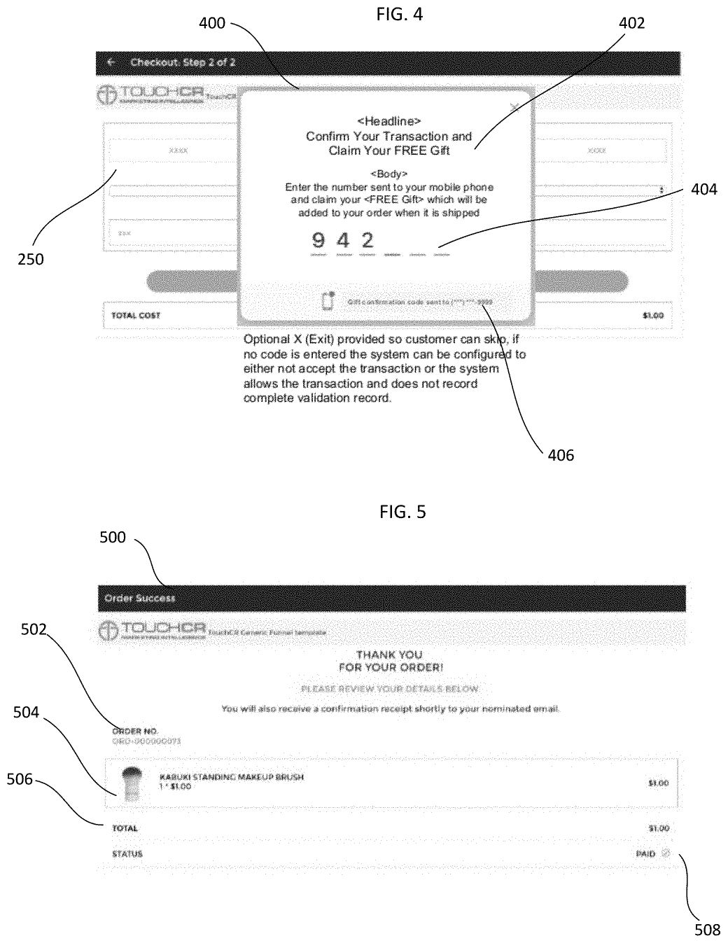

FIG. 4 is a screen image of a pop-up window 400 that appears on the checkout screen 250 shown in FIG. 250. The pop-up window 400 allows the consumer to enter the code received through their mobile device 110 to verify the transaction. The pop-up window 400 includes an incentive instruction field 402 and a code entry field 404. The incentive instruction field 402 includes instructions to enter the code and a reminder of the incentive such as a free gift that will be made available to the customer on entering the code. Once the code is entered, a gift information graphic 406 is displayed. In this example, the gift information graphic 406 includes a confirmation that a gift certificate code has been sent to the mobile number via a SMS message. The inclusion of an incentive is an option to incentivize customers to provide the code number and is not required for the operation of the system 100.

The customer will enter the received code in the code entry field 404 to ensure that the transaction is proper. The entered code is then sent to the transaction security server 104. The entered code is then compared with the generated code at the transaction security server 104 for validation of the code. If the entered code is valid, the transaction is processed based on the received credit card information from the interface 250. The transaction security server 104 may also execute a routine to provide the incentive offered previously. For example, if the incentive was a gift, the transaction security server 104 may cause an SMS message to be sent with a gift code. The customer may then visit the merchant website and enter the gift code to claim a free gift. If the entered code is invalid, then the webpage will prompt the user to reenter the security code. To help defend against attacks, after a predetermined number of tries, the system 100 will not accept additional entries and require the generation and resending of a new code. After a predetermined number of resends the system 100 will block the use of the system 100 against the mobile number and email address altogether.

The validation involves checking different factors that leverage validation of the SMS recording against the customer and order record. The date and time code is generated and sent out and thus proper time and date sequencing must be observed on the receiving of the code from the consumer. This time window is configurable but is preferably set to 15 minutes and the message is deemed no longer valid after the time window. The mobile phone number message must be sent to the correct mobile phone associated with the received mobile phone number. The generated code must be validated by the consumer by submitting the generated code to the transaction security server 104. The date and time of the validation code entry must be received within the time of the configured time window from the time the code was sent. The verification that the SMS code was valid, the time window for the use of the SMS code, the mobile phone number used, the browser IP address captured, and the date and time of the entry of the code recorded within the context of the credit card transaction are all factors that validate that the customer is the actual card holder and thus prevent fraudulent denial of transactions.

If the validation is successful, the transaction result is recorded on the transaction security server 104 and the merchant server 102. The transaction details are then forwarded to the payment processing system 108. An optional confirmation page may then be displayed on the mobile device 110 or the computing device 112 in FIG. 1. FIG. 5 shows a confirmation page 500 displayed by the browser when the verification of the credit card is successful and the transaction is completed. The confirmation page 500 includes an order number field 502, a product summary field 504, a total purchase field 506 and a status field 508. The order number field 502 is assigned by the merchant server 102 to track the transaction. The merchant server 102 provides the product information for the product summary field 504 and the total amount of the purchase in the total purchase field 506. The stats field 508 provides information as to the status of the order, which in this example has been assigned a status of paid since the transaction was verified.

Alternatively, the system can be configured to skip the necessity of the code or to enforce the code procedure based on the above procedure. An optional X (Exit) selection may be provided on the checkout interface 250 to allows a customer to skip entering the code. If no code is entered, the system 100 can be configured to either not accept the transaction or the system allow the transaction but does not record a complete validation record.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A system to validate a remote transaction, the system comprising:
a merchant webserver that generates a transaction interface on a device accessible by a consumer, wherein the transaction interface allows entry of a mobile phone number and a credit card number;
a transaction security server operable to receive the mobile phone number and the credit card number, the transaction security server generating a code and sending the generated code to a mobile device corresponding to the entered mobile phone number;
wherein, the transaction interface generates a code entry screen, and wherein the transaction security server verifies the transaction based on the received credit card number if an entered code from the code entry screen matches the generated code.

2. The system of claim 1, wherein the mobile device receives the transaction interface.

3. The system of claim 1, wherein the transaction interface is generated on a computing device accessible by the customer.

4. The system of claim 1, wherein the transaction interface allows entry of a credit card CVV and expiration date.

5. The system of claim 1, wherein the transaction interface includes an incentives field that offers the customer an incentive to enter the mobile phone number.

6. The system of claim 5, wherein the transaction security server is operative to send an incentive code to allow the customer to redeem the incentive if an entered code is received.

7. The system of claim 1, further comprising a database coupled to the transaction security server, the transaction security server storing customer information and credit card information in the database, wherein the transaction security server checks whether the entered mobile phone number is valid for the customer via the database prior to sending the generated code.

8. The system of claim 1, wherein the generated code is sent to the mobile device via SMS.

9. A method of protecting the security of transactional information, comprising:
generating a transaction interface on a customer computing device on a request for a credit card transaction, the interface requesting a mobile phone number and a credit card number;
generating a code via a transaction security server;
sending the code to a mobile device associated with the mobile phone number;
presenting a code entry interface requesting the customer to input the generated code;
validating the received code against the generated code; and
authorizing the credit card transaction based on the validation of the received code and the received credit card information.

10. The method of claim 9, further comprising on receiving the credit card transaction request, creating a customer record associated with the mobile number and a transaction record in a memory device.

11. The method of claim 9, wherein the mobile device is the customer computing device.

12. The method of claim 9, wherein the transaction interface allows entry of a credit card CVV and expiration date.

13. The method of claim 9, wherein the transaction interface includes an incentives field that offers the customer an incentive to enter the mobile phone number.

14. The method of claim 13, further comprising sending an incentive code to allow the customer to redeem the incentive if an entered code is received.

15. The method of claim 9, further comprising checking whether the entered mobile phone number is valid for the customer via a database prior to sending the generated code.

16. The method of claim 9, wherein the generated code is sent to the mobile device via SMS.
